(19) United States
(12) Patent Application Publication
(10) Pub. No.: US 2017/0285612 A1
(43) Pub. Date: Oct. 5, 2017

(54) APPARATUS AND METHOD OF OPTIMIZATION MODELING FOR FORMING SMART PORTFOLIO IN NEGAWATT MARKET

(71) Applicant: ADVANCED INTITUTES OF CONVERGENCE TECHNOLOGY, Gyeonggi-do (KR)

(72) Inventors: Mi-jeom KIM, Gyeonggi-do (KR); Jung-in CHOI, Seoul (KR)

(73) Assignee: ADVANCED INSTITUTES OF CONVERGENCE TECHNOLOGY, Gyeonggi-do (KR)

(21) Appl. No.: 15/186,262

(22) Filed: Jun. 17, 2016

(30) Foreign Application Priority Data
Mar. 30, 2016 (KR) 10-2016-0038125

(51) Int. Cl. G05B 19/406

(52) U.S. Cl. CPC G05B 19/406; G05B 2219/35499

(57) ABSTRACT

An apparatus and method for smart portfolio optimization modeling for optimum demand response resource configuration in order to solve problems that it is difficult to collect customer objects corresponding to demand response resources and to obtain power reduction reliability and power reduction quantity of customer objects and real-time metering information about loads whose power can be reduced since conventional customer objects have a low demand response resource recognition rate and problems that power is supplied to only customer objects collected in a power exchange in power feeding according to power supply and demand situations since an apparatus for optimization modeling for a portfolio composed of optimized demand response resources is not present and thus many customer objects on which a power feed instruction is not executed are generated, decreasing a power reduction implementation rate. The apparatus includes a smart meter 100, a demand response resource network generator 200 and a smart portfolio optimization modeling control module 300 to measure metering data with respect to hourly electricity prices and hourly electricity consumption loads in real time by installing a smart meter in a customer object, to improve a customer object collection rate by as much as about 70% compared to conventional cases through supply of the smart meter free of charge and public relations and advertisement about payment of adjusted amount corresponding to saved power quantity, to generate a demand response resource network for reducing power of loads on the basis of IDs of smart meters installed in collected customer objects, thereby performing remote power monitoring and remote power control and to achieve optimization modeling for a portfolio composed of optimized demand response resources by combining customer objects, power consumption of which is to be reduced, so as to maximize power reduction on the basis of RIM net benefit maximization and energy savings maximization, thereby enhancing a power reduction implementation rate according to power supply and demand state as much as about 80% and revitalizing the negawatt market.

### CROSS-REFERENCE TO RELATED APPLICATION

This application claims priority from Korean Patent Application No. 10-2016-0038125, filed on 30 Mar. 2016, in the Korean Intellectual Property Office, the disclosure of which is incorporated herein by reference in its entirety.

### FIELD OF THE INVENTION

The present invention relates to an apparatus and method for optimization modeling for forming a smart portfolio for optimum demand response resource configuration, which can measure metering data with respect to hourly electricity prices and hourly electricity consumption of loads a real time by installing a smart meter in a customer object and form optimization modeling for a portfolio composed of optimum demand response resources by combining customer objects, power consumption of which is to be reduced, so as to maximize power reduction and profits on the basis of RIM (Ratepayer Impact Measure) net benefit maximization, energy savings maximization, and profit maximization according to demand response resource management.

### DISCUSSION OF RELATED ART

As social costs for electric power supply sharply increase, it is difficult to meet the rapidly increasing demand for electric power, and thus power supply policy was changed from a supply-oriented policy to a demand-oriented policy.

Laws were revised such that load aggregators can perform power transaction in the power market in 2014 and a related demand management market was opened in November 2014.

Power demand management classified into demand response (DR) and energy efficiency. DR refers to an activity that adjusts a normal power consumption pattern to manage power demand by enabling an electric power user to respond to electric charges (price signals) or other monetary inducement. Demand response resources are resources that can reduce power loads through a plurality of customers participating in demand response (customer objects). Demand response resources refer to resources that can be reduced according to a power feed instruction of a power exchange on the basis of power demand and supply situation.

However, since customer objects have a low demand response resource recognition rate, it is difficult to collect customer objects corresponding to demand response resources and to obtain power reduction reliability and power reduction quantity of customer objects and real-time metering information about loads whose power can be reduced.

Furthermore, since an apparatus for optimization modeling for a portfolio composed of optimized demand response resources by combining customer objects, power consumption of which is to be reduced, to maximize power reduction is not present, power is supplied to only customer objects collected in a power exchange in power feeding according to power supply and demand situations. Accordingly, many customer objects on which a power feed instruction is not executed are generated, decreasing a power reduction implementation rate.

A relevant prior art document is Korean patent publication 10-1412738.

### SUMMARY OF EMBODIMENTS OF THE INVENTION

It is a purpose of embodiments of the present invention to provide an apparatus and method for optimization modeling for forming a smart portfolio for optimum demand response resource configuration, which can measure metering data with respect to hourly electricity prices and hourly electricity consumption of loads in real time by installing a smart meter in a customer object, improve a customer object collection rate, perform remote power monitoring and rename power control, and from optimization modeling for a portfolio composed of optimized demand response resources by combining customer objects, power consumption of which is to be reduced, so as to maximize power reduction on the basis of RIM net benefit maximization and energy savings maximization.

The above and other purposes can be accomplished by the provision of an apparatus for smart portfolio optimization modeling for optimum demand response resource configuration, including: a smart meter 100 installed in a customer object, operating upon reception of a measurement signal from a smart portfolio optimization modeling control module and transmitting metering data with respect to an hourly electricity price and hourly electricity consumption of a load installed in the customer object to the smart portfolio optimization modeling control module; a demand response resource network generator 200 for online collecting customer objects, power consumption of which is to be reduced, and generating a demand response resource network for reducing power of loads on the basis of IDs of smart meters installed in the collected customer objects; and the smart portfolio optimization modeling control module 300 connected to smart meters, sending the measurement signal to the smart meters, receiving metering data in response to the measurement signal, setting priority of demand response resources in consideration of loads of the customer objects included in the demand response resource network, and applying a reference weight to demand response resources to optimize the portfolio.

As described above, the disclosed system can measure metering data with respect to hourly electricity prices and hourly electricity consumption loads in real time by installing a smart meter in a customer object. Accordingly, it is possible to easily detect power demand and supply state.

In addition, the system can improve a customer object collection rate by as much as about 70% compared to conventional cases through supply of the smart meter free of charge and public relations and advertisement about payment of adjusted amount corresponding to saved power quantity.

Furthermore, the system can generate a demand response resource network for reducing power of loads on the basis of IDs of smart meters installed in collected customer objects, and thus remote power monitoring and remote power control can be performed.

Moreover, the system can form optimization modeling for a portfolio composed of optimized demand response resources by combining customer objects, power consumption of which is to be reduced, so as to maximize power reduction on the basis of RIM net benefit maximization and energy savings maximization. Accordingly, a power reduction implementation rate according to power supply and demand state can be enhanced by as much as about 80% and the negawatt market can be revitalized.

### BRIEF DESCRIPTION OF THE DRAWING

The above and other objects, features, and advantages of the present invention embodiments will be more clearly understood from the following detailed description taken in conjunction with the accompanying drawing, in which:

FIG. 1 is a block diagram of an apparatus 1 for smart portfolio optimization modeling for optimum demand response resource configuration according to an embodiment of the present invention;

FIG. 2 illustrates a configuration of the apparatus of FIG. 1 for smart portfolio optimization modeling for optimum demand response resource configuration;

FIG. 3 is a block diagram of a smart meter of FIGS. 1 and 2;

FIG. 4 illustrates an exemplary operation of controlling loads to correspond to a reference set value in response to a frequency of an electrical grid through a smart load controller according to an embodiment of the present invention;

FIG. 5 is a block diagram of the smart portfolio optimization modeling control module of FIGS. 1 and 2;

FIG. 6 is a block diagram of the smart portfolio optimization modeling controller of FIG. 5;

FIG. 7 is a block diagram of the portfolio optimization modeling unit of FIG. 6;

FIG. 8 illustrates the exteriors of smart meters according to an embodiment of the present invention;

FIG. 9 illustrates an operation of a demand response resource network generator to online collect customer objects, power consumption of which is to be reduced, and then generate a demand response resource network for reducing power of loads on the basis of IDs of smart meters installed in the collected customer objects according to an embodiment of the present invention;

FIG. 10 is a flowchart illustrating a method for optimization modeling for a smart portfolio composed of optimized demand response resources according to an embodiment of the present invention;

FIG. 11 illustrates a step of forming optimization modeling for a smart portfolio composed of optimum demand response resources for optimizing RIM net benefit through a pricing function indicating a degree of participation of customer objects corresponding to demand response resources according to variations in subsidiaries applied to smart meters installed in the customer objects, through a RIM net benefit maximization algorithm engine, included in a step of forming portfolio optimization modeling according to an embodiment of the present invention;

FIG. 12 illustrates a step of forming optimization modeling for maximizing energy savings on the basis of metering data with respect to hourly electricity prices and hourly electricity consumption of loads installed in customer objects, through an EV algorithm engine, included in the step of forming portfolio optimization modeling according to an embodiment of the present invention; and

FIG. 13 illustrates a step of setting an incentive (won/kW) according to power reduction quantity of loads to form optimization modeling of customer objects participating in demand response resources in order to maximize profits according to demand response resource management, through an incentive DR profit optimization algorithm engine, included in the step of forming portfolio optimization modeling according to an embodiment of the present invention.

### DETAILED DESCRIPTION OF THE EMBODIMENTS OF THE INVENTION

In an apparatus for optimization modeling for forming a smart portfolio for optimum demand response resource configuration described in the present invention, portfolio optimization modeling refers to modeling for achieving maximization of RIM (Ratepayer Impact Measure) net benefit, maximization of energy savings and profit maximization according to demand response resource management, which is preset and constructed in consideration of loads of customer objects associated with demand response resources or a negawatt market.

In addition, a customer object described in the present invention refers to a customer participating in demand response, such as home and industry, and means an end electricity consumer who actually reduces electric power loads and constitutes demand response resources.

The negawatt market refers to a power market that creates profit by collecting electricity saved by consumers in factories, markets, buildings and the like and selling collected electricity.

Specifically, the negawatt market is classified into a reliability demand response market that perform obligatory reduction and an economic demand response market according to voluntary bidding.

Reliability demand response (peak reduction DR) needs to follow reduction instructions within one hour when a power feed instruction is issued from a power exchange in case of a power demand-supply crisis corresponding to reserve power of less than 5,000,000 kW. Reliability demand response is for the purpose of increasing reliability of power systems, reducing peak power and coping with instability of supply and demand.

In economic demand response (charge reduction DR), load aggregators voluntarily submit bids upon determining that a demand resource reduction price is lower than a generation cost. When a load aggregator submits a bid in the negawatt market a day earlier and wins the bid, a system marginal price (SMP) can be reduced. That is, load aggregators submit bids for power reduction quantity in the negawatt market and create profits through price competition with a generator.

When a demand resource reduction price (bid price) is lower than a generation cost in the same period, the corresponding load aggregator wins the bid.

Loads according to the present invention in an air-conditioner, a heater, devices necessary for production, injection machines included in a factory production line, a computer, a light fixture and power devices for living, which consume electricity.

A description will be given of preferred embodiments of the present invention with reference to the attached drawings.

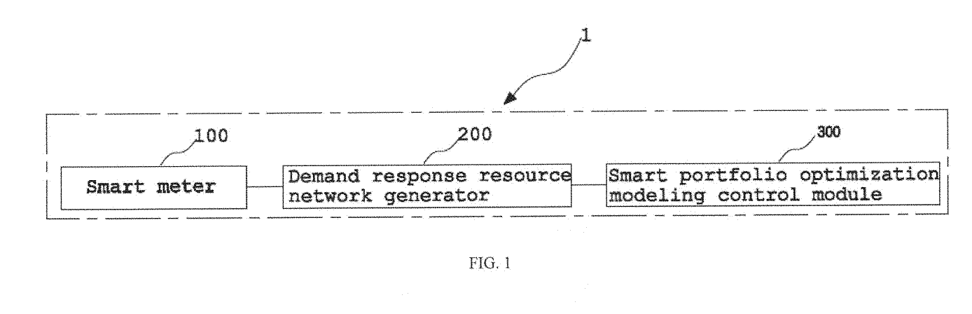

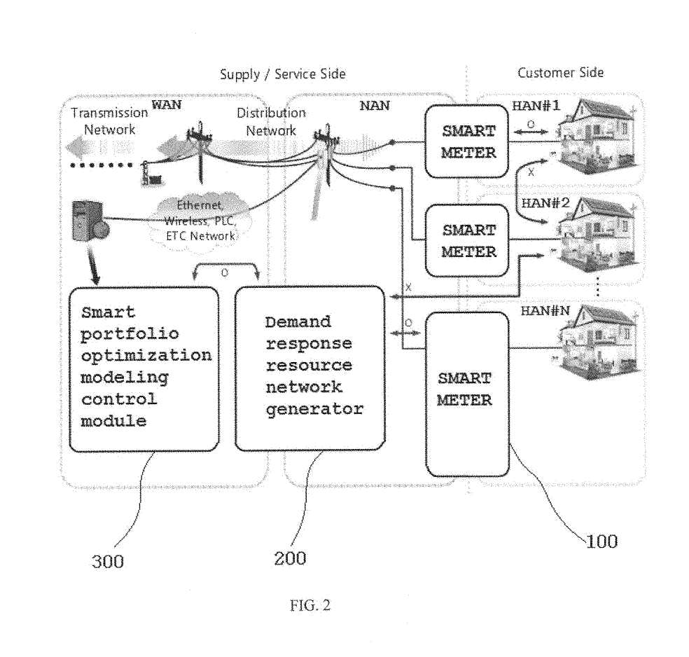

FIG. 1 is a block diagram of an apparatus 1 for optimization modeling of a smart portfolio for forming optimized demand response resources according to an embodiment of the present invention, and FIG. 2 illustrates a configuration of the apparatus 1 for optimization modeling of a smart portfolio for forming optimized demand response resources. The apparatus 1 includes a smart meter 100, a demand response resource network generator 200, and a smart portfolio optimization modeling control module 300.

The smart meter 100 is installed in a customer object, operates upon reception of a measurement signal from the smart portfolio optimization modeling control module and transmits metering data with respect to an hourly electricity price and hourly electricity consumption of a load installed in the customer object to the smart portfolio optimization modeling control module.

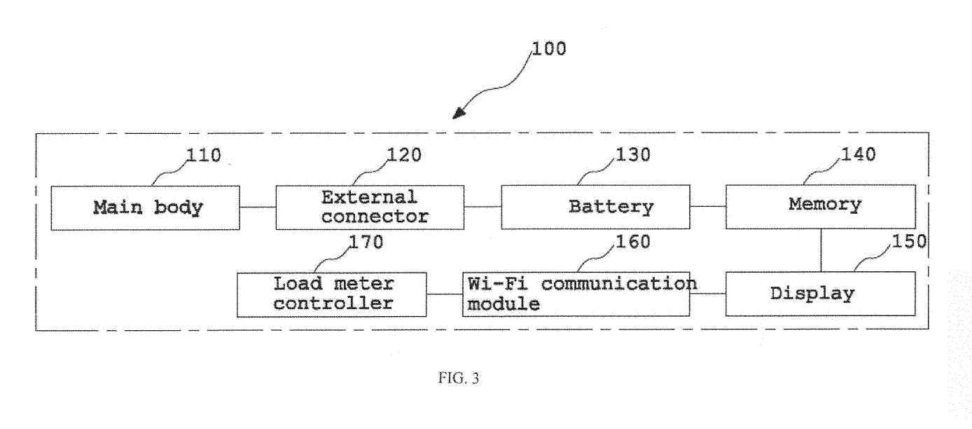

The smart meter 100 includes a main body 110, an external connector 120, a battery 130, a memory 140, a display 150, a Wi-Fi communication module 160, and a load meter controller 170, as shown in FIG. 3.

The main body 110 has a box shape and protects and supports each device of the smart meter 100 from external pressure.

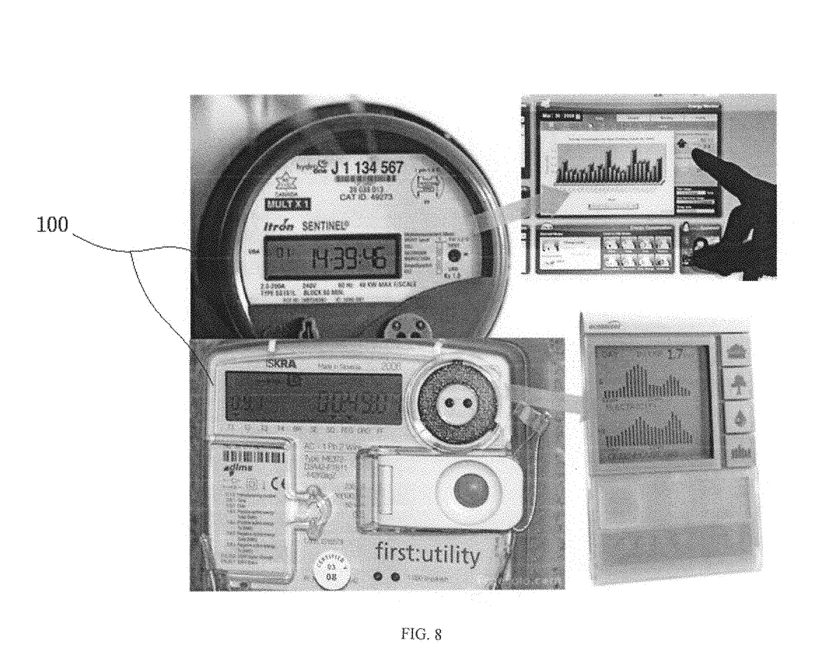

Referring to FIG. 8, the external connector is provided to one side of the exterior of the body 110, the battery, the memory, the Wi-Fi communication module, and the load meter controller are provided to one side of the inside of the main body, and the display is provided to the upper part of the surface of the main body.

The main body is made of an aluminum alloy having high heat-radiation and durability.

The external connector 120 is positioned at one side of the exterior of the main body and connects the smart meter 100 to an input/output terminal of a load installed in a customer object. The external connector 120 has positive (+) and negative (−) connectors and is connected to the input/output terminal of the load.

The battery 130 is provided to one side of the inside of the main body and provides power to each device. The battery 130 may be a lithium-ion battery.

The memory 140 is provided to onside of the battery and stores metering data with respect to an hourly electricity price and hourly electricity consumption of the load.

The display 150 is provided to the surface of the main body and displays current driving state and metering data of the load on a screen. The display 150 is configured in the form of an LCD monitor or an LED monitor.

The Wi-Fi communication module 160 transmits the metering data with respect to the hourly electricity price and hourly electricity consumption of the load to the remotely located smart portfolio optimization modeling control module, receives a control command signal in response to the metering data and delivers the control command signal to the load meter controller. The Wi-Fi communication module 160 is assigned a unique ID and forms a demand response resource network through the demand response resource network generator.

The load meter controller 170 is connected to the external connector, the battery, the memory, and the display to control operations thereof, sends a measurement signal to a load to be measured, generates metering data about an hourly electricity price and hourly electricity consumption of the load, stores the metering data in the memory, transmits the metering data to the smart portfolio optimization modeling control module through the Wi-Fi communication module, and outputs a power feed control signal to the load according to a real-time power feed instruction signal of the smart portfolio optimization modeling control module. The load meter controller 170 is composed of a PIC one-chip microcomputer.

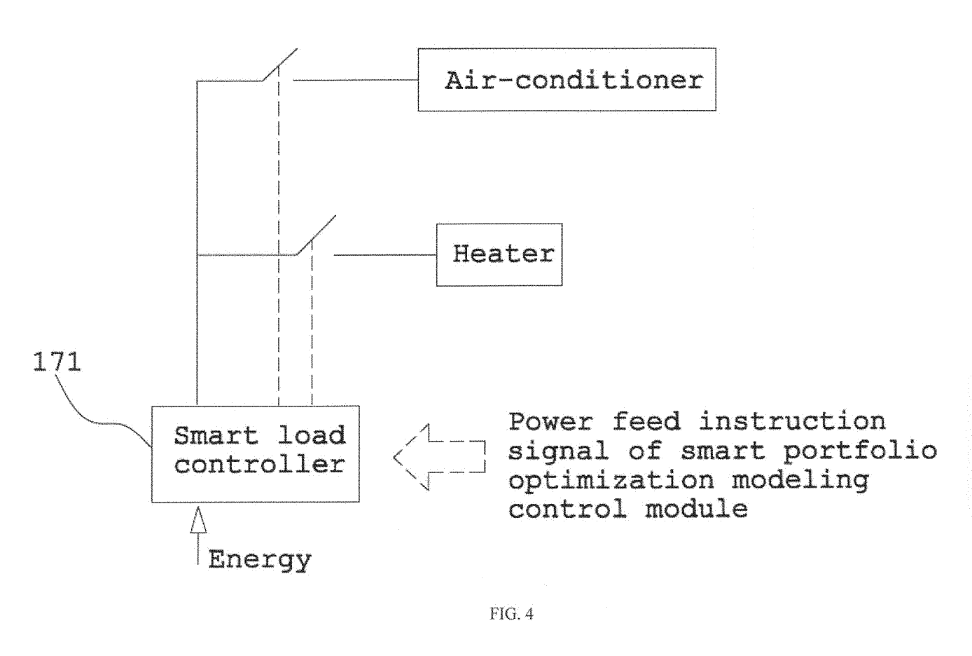

In addition, the load meter controller 170 includes a smart load controller 171, as shown in FIG. 4.

The smart load controller 171 adjusts loads to a reference set value in response to the frequency of an electrical grid for improvement of demand-supply state of a power system and optimization for an electricity price. Here, adjustment of loads refers to blocking power of loads to reduce power.

The smart load controller 171 is driven by the power feed control signal according to the real-time power feed instruction signal of the smart portfolio optimization modeling control module.

The smart load controller 171 controls energy consumption by controlling on/off of power supply to each device in a predetermined control direction while monitoring the quantity of energy used.

The smart load controller 171 is configured to respond to the frequency of an electrical grid. That is, the smart load controller 171 is configured to reduce load usage when the frequency decreases and to increase load usage when the frequency increases, like AGC (Automatic Generation Control) in the electrical grid.

In addition, the smart load meter according to the present invention may include a commercial power supply instead of the battery. The commercial power supply provides commercial power to each device.

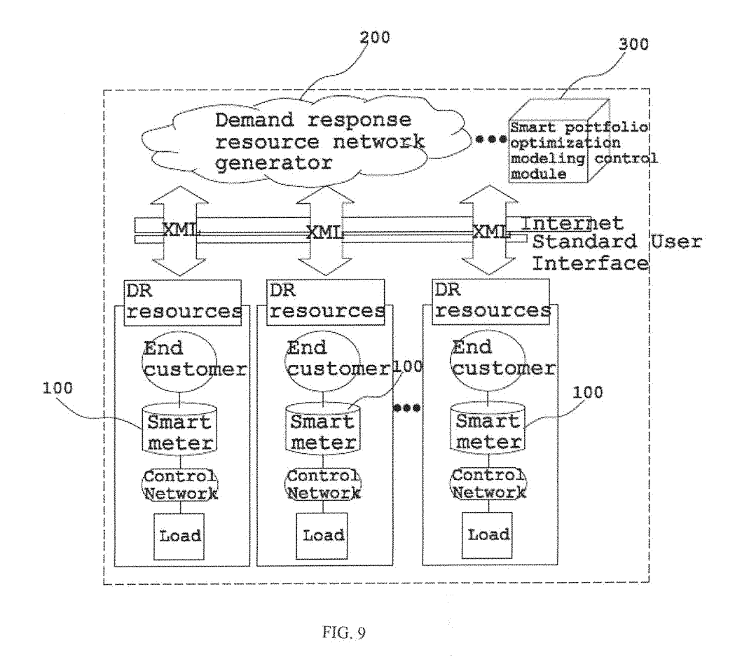

Referring to FIG. 9, the demand response resource network generator 200 collects customer objects, power consumption of which is to be reduced, through an online site and generates a demand response resource network for reducing power of loads on the basis of IDs of smart meters installed in the collected customer objects. Here, the online site refers to a demand response resource collecting site operating through a web of a PC or a smartphone application.

The demand response resource network groups demand response resources on the basis of IDs of smart meters through a Wi-Fi communication network. Thereafter, the demand response resource network groups optimum demand response resources that maximize power reduction according to a control signal of the smart portfolio optimization modeling control module.

In addition, the demand response resource network generator 200 according to the present invention may generate a demand response resource network for reducing power of loads using a PLC (Power Line Communication) network instead of a Wi-Fi communication network.

The smart portfolio optimization modeling control module 300 is connected to the smart meter, sends a measurement signal to the smart meter, receives metering data from the smart meter in response to the measurement signal, sets priority of demand response resources in consideration of loads of customer objects in the demand response resource network, and adds a reference weight to a demand response resource to optimize a portfolio.

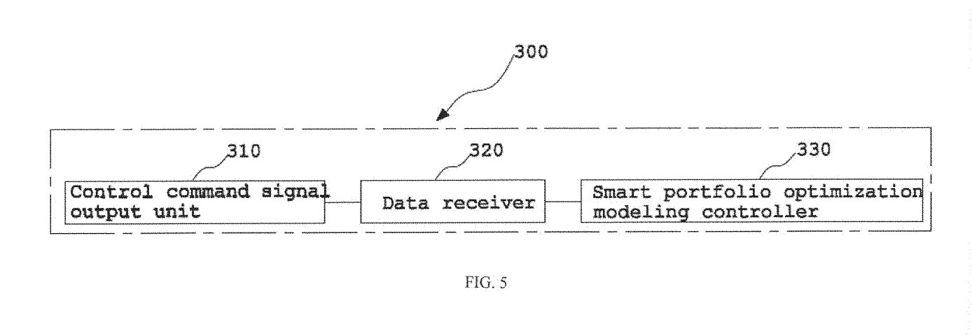

Referring to FIG. 5, the smart portfolio optimization modeling control module 300 includes a control command signal output unit 310, a data receiver 320, and a smart portfolio optimization modeling controller 330.

The control command signal output unit 310 is connected to the smart meter through the demand response resource network and outputs a measurement signal and a control command signal with respect to a power feed control signal to the smart meter. The control command signal output unit 310 includes a control command unit and an operating unit.

The control command unit generates a control command signal indicating how to control a control target detected from an external signal.

The operating unit amplifies a control command from the control command unit, considers safety measures and directly controls the control target.

The data receiver 320 receives metering data corresponding to an hourly electricity price and hourly electricity consumption of a load from the demand response resource network and delivers the same to the smart portfolio optimization modeling controller 330.

The smart portfolio optimization modeling controller 330 sets priority of demand response resources on the basis of metering data corresponding to hourly electricity prices and hourly electricity consumption of loads, delivered from the data receiver, outputs a measurement signal and a power feed control signal to a smart meter corresponding to a demand response resource having high priority according to power demand-and-supply conditions, applies a reference weight to a customer object one of demand response resources, which can reduce power of loads, and then combines customer objects, power consumption of which is to be reduced, to achieve portfolio optimization modeling for forming optimum demand response resources.

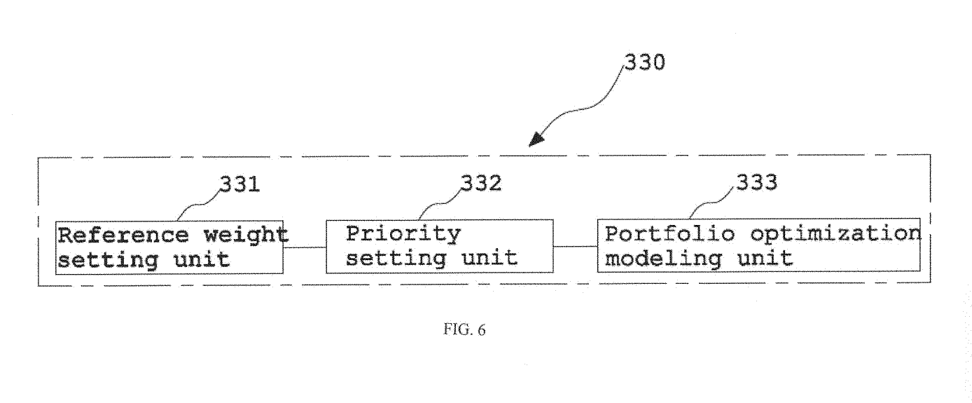

Referring to FIG. 6, the smart portfolio optimization modeling controller 330 includes a reference weight setting unit 331, a priority setting unit 332, and a portfolio optimization modeling unit 333.

The reference weight setting unit 331 sets a reference weight corresponding to one of power reduction reliability, power reduction quantity, type and number of loads whose power can be reduced, a regular electricity consumption pattern, and type and properties of a customer object.

Here, the power reduction reliability is measured on the basis of history and corresponds to quality. In this case, a reference weight is set to a and a weight value is set to 0.4.

The power reduction quantity refers to power reduction quantity of a load, measured by the smart meter. In this case, a reference weight is set to b and a weight value is set to 0.3.

The type and number of loads whose power can be reduced (complexity) refer to the type and number of loads whose power can be reduced, which are connected to the smart meter. In this case, a reference weight is set to c and a weight value is set to 0.1.

The regular electricity consumption pattern is a result of analysis of regular electricity consumption of a load connected to the smart meter according to RRMSE (Relative Root Mean Squared Error). The regular electricity consumption pattern is improved as RRMSE decreases. In this case, a reference weight is set to d and a weight value is set to 0.2.

The types and properties of a customer object refer to detecting customer objects which can complement each other and grouping the same into one resource in order to consider an hourly complementary relation. In this case, a reference weight is set to e and a weight value is set to 0.2.

The priority setting unit 332 sets whether a customer object of a demand response resource is located in a capital area (Seoul, Gyeonggi, and Incheon) or a noncapital area (Jeju) to first priority, groups customer objects in consideration of power reduction quantity and hourly complementary relation, sets a customer object of a demand response resource having obligatory reduction quantity exceeding a minimum reference set value and less than a maximum reference set value, to second priority, and sets a demand response resource, to which customer objects corresponding to a minimum reference participation number per demand response resource are set, to third priority.

That is, demand response resources are resources that can be bid on in the market a day in advance having a real-time power feed instruction execution duty for obligatory reduction quantity for a transaction period, and need to be differently registered for the capital area (Seoul, Gyeonggi, and Incheon) and the noncapital area (Jeju). The minimum reference set value of the obligatory reduction quantity is set to 10 MW to 50 MW and the maximum reference set value is set to 400 MW to 800 MW.

Here, the minimum reference set value and the maximum reference set value are variable according to situation and purpose, and the minimum reference set value and the maximum reference set value are preferably set to 20 MW and 500 MW, respectively.

To improve load reduction reliability through portfolio management of load aggregators under the control of the smart portfolio optimization modeling control module, customer objects corresponding to the minimum reference participant number per demand response resource are set. This is exemplary. At least five to twenty customers per demand response resource need to be registered, and registration change is permitted once every quarter for cancellation of registration of a customer and new registration of a new electricity consumer.

Even when a demand response participating customer is registered or cancelled, obligatory reduction quantity of the corresponding demand response resource is not changed.

The minimum reference participant number per demand response resource is variable according to situation and purpose. It is desirable to register ten customers participating in demand response.

The portfolio optimization modeling unit 333 combines customer objects that want to reduce power to maximize power reduction and form a portfolio optimization modeling composed of optimum demand response resources on the basis of maximization of RIM net benefit and maximization of energy savings.

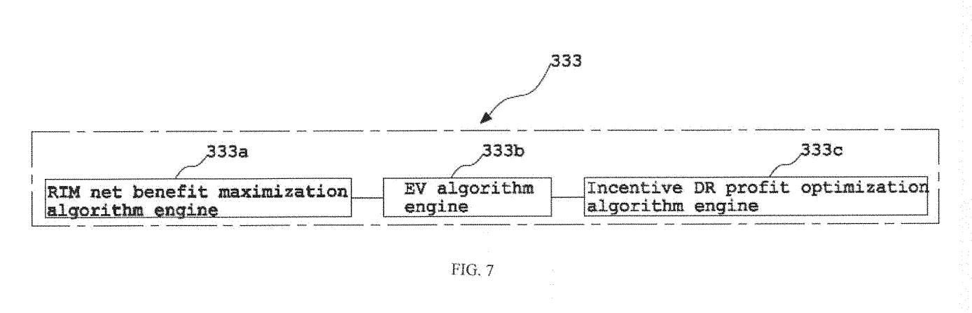

Referring to FIG. 7, the portfolio optimization modeling unit 333 includes an RIM (Ratepayer Impact Measure) net benefit optimization algorithm engine 333a and an EV algorithm engine 333b.

### RIM Net Benefit Optimization Algorithm Engine 333a

The RIM net benefit optimization algorithm engine 333a forms optimization modeling of a portfolio composed of optimum demand response resources for optimizing RIM net benefit through a pricing function that indicates a degree of participation of customer objects corresponding to demand response resources according to variations in subsidies applied to smart meters installed in customer objects. The RIM net benefit optimization algorithm engine 333a analyzes the influence of variations in earnings of an electric power company and charges on smart load meters on power rates.

That is, the RIM net benefit optimization algorithm engine 333a represents that subsidies are all cancelled with time and changed to free of charge and suggests optimization modeling for maximizing RIM using a pricing function indicating a degree of participation of demand response resources according to subsidy variation.

An objective function that optimizes customer object impact net benefit is represented by Equation 1.

$$Customer object impact net benefit = {\sum }_{i = 1}^{k} ( {B}_{i} ( t ) - {C}_{i} ( t ) ) = {\sum }_{i = 1}^{K} {\sum }_{n = 1}^{N} ( \frac{{UAC}_{n}^{i} ( t )}{{( 1 + d )}^{n - 1}} - \frac{{PRC}_{n}^{i} ( t ) + {INC}_{n}^{i} ( t ) + {LR}_{n}^{i} ( t )}{{( 1 + d )}^{n - 1}} ) = {\sum }_{i = 1}^{k} ( {AC}_{i} ( t ) \times {PWF}_{i} - {RR}_{i} ( t ) - {IL}_{i} ( t ) \times {PWF}_{i} ) \times {RP}_{i} ( t ) {PWF}_{i} = [ {( 1 + r )}^{{n}_{i} - 1} ] / [ {( 1 + r )}^{{n}_{i} - 1} \times r ] + 1 ( PresentWorthFactor ) \qquad Equation 1$$

Here, ACᵢ indicates an avoided cost of a smart meter i, PRCᵢ indicates a program cost of the smart meter i, RPᵢ(t) represents regulated penetration of the smart meter in a given year t, ILᵢ represents a charge income decrease (won) according to propagation of the smart meter i, and RRᵢ(t) represents a changed subsidy for the smart meter i in the year t.

In addition, PWFᵢ indicates a present worth factor of the smart meter i in consideration of a discount rate r and appliance lifetime n, and k indicates the number of smart meters.

In Equation 1, the avoided cost corresponds to benefit, and the program cost, subsidies and charge income decreases correspond to expenses.

Accordingly, when the total cost is subtracted from the avoided cost, the result becomes RIM net benefit. Equation 1 refers to maximization of the net benefit.

Here, as a subsidy variable RRᵢ(t) per smart meter in the year t changes, penetration of the smart meter, RPᵢ(t), changes. Accordingly, the penetration of the smart meter, RPᵢ(t), is a value varying with a subsidy and a portfolio per program is varied according to how rationally RPᵢ(t) is estimated.

In the present invention, a spread function considering a pricing function is configured in order to estimate RPᵢ(t).

Constraint conditions are represented by Equation 2.

$${\sum }_{i = 1}^{k} ( {RR}_{i} ( t ) \times {RP}_{i} ( t ) ) \leq {\sum }_{i = 1}^{k} ( {ER}_{i} ( t ) \times {P}_{i} ( t ) ) \\ 0 < {RR}_{i} ( t ) \leq {RR}_{i} ( t - 1 ) \times α \qquad Equation 2$$

Here, ERᵢ(t) indicates a subsidy for the smart meter i in the year t, RRᵢ(t) indicates a changed subsidy for the smart meter i in the year t, Pᵢ(t) represents penetration with respect to the subsidy of the smart meter i in the year t, RPᵢ(t) represents penetration with respect to the changed subsidy for the smart meter i in the year t, and α indicates a variable indicating a maximum subsidy of the year t compared to a year t-1.

That is, Equation 2 represents that total investment costs changed in response to subsidy variation of smart meters need to be less than or equal to total investment costs according to previous subsidies as in an operating profit maximization method.

In addition, a subsidy for smart meter in the year t needs to be less than α times the subsidy of the year t-1, and α is set such that market turmoil due to abrupt subsidy increase is minimized.

Accordingly, it is possible to achieve optimization modeling of a portfolio composed of optimum demand response resources for optimizing RIM net benefit through the pricing function indicating a degree of participation of customer objects corresponding to demand response resources according to variation in subsidies applied to smart meters.

### EV (Energy Savings) Algorithm Engine 333b

The EV algorithm engine 333b forms optimization modeling for maximizing energy savings on the basis of metering data with respect to hourly electricity prices and hourly electricity consumption of loads installed in customer objects.

That is, EV algorithm engine 333b suggests optimization modeling for maximizing energy savings corresponding to major performance of demand response resources. An objective function for optimization is represented by Equation 3.

$$Energy savings maximization = {\sum }_{i = 1}^{k} {RP}_{t} \times {EV}_{i} \times {N}_{i} \qquad Equation 3$$

Here, RPₜ indicates regulated penetration of the smart meter i in the year t, EVi indicates energy savings of the smart meter i. Nᵢ represents device lifetime and k represents the number of smart meters.

Equation 3 represents maximization of the sum of energy savings for the lifetime of smart meters.

The penetration of a smart meter is a value variable according to subsidy, and a portfolio per program is varied according to how much RPi(t) is rationally estimated.

The present invention configures a spread function considering a pricing function in order to estimate RPₜ.

An optimum condition of optimization modeling for maximizing energy savings is represented by Equation 4.

$${\sum }_{i = 1}^{k} ( {RR}_{i} ( t ) ) \leq {\sum }_{i = 1}^{k} ( {ER}_{i} ( t ) \times {P}_{i} ( t ) ) \\ 0 < {RR}_{i} ( t ) \leq {RR}_{i} ( t - 1 ) \times α \qquad Equation 4$$

Here, ERᵢ(t) indicates a subsidy for the smart meter i in the year t, RRᵢ(t) indicates a changed subsidy for the smart meter i in the year t, Pᵢ(t) represents penetration according to the subsidy for the smart meter i in the year t, and α represents a variable indicating a maximum subsidy in the year t compared with the year t-1.

That is, the condition represented by Equation 4 means that investment costs of smart meters, which are changed in response to subsidy variation, need to be less than or equal to total investment costs of smart meters according to previous subsidies.

In addition, the subsidy for the corresponding smart meter in the year t needs to be less than α times the subsidy of the year t-1, and α becomes a decision element that minimizes market turmoil due to abrupt subsidy increase.

Through the aforementioned procedure, optimization modeling for maximizing energy savings is formed on the basis of metering data corresponding to hourly electricity prices and hourly electricity consumption of loads.

The smart portfolio optimization modeling controller according to the present invention includes an incentive DR profit optimization algorithm engine 333c.

The incentive DR profit optimization algorithm engine 333c sets an incentive (won/kW) in response to power savings of loads and forms optimization modeling of customer objects participating in demand response resources to minimize demand response resource management costs, thereby maximizing profits according to management of demand response resources.

Here, the incentive is a cost converted from power savings of loads. The incentive increases as power savings (load reduction) of loads increase.

For example, five customer objects are notified of eight DR event periods. One DR event period is set to one hour.

TABLE 1

| | Increase/ | Power generation | | | Stop time | |
|---|---|---|---|---|---|---|
| | decrease | reduction | Load reduction quantity | | Minimum | Minimum |
| Customer | rate | rate | Maximum | Minimum | reduction | stop |
| object | (kW/min) | (kW/min) | (kW) | (kW) | (hour) | (hour) |
| 1 | 28 | 158 | 65 | 20 | 2 | 4 |
| 2 | 32 | 220 | 50 | 15 | 2 | 1 |
| 3 | 23 | 29 | 79 | 35 | 2 | 3 |
| 4 | 30 | 20 | 100 | 45 | 2 | 3 |
| 5 | 29 | 16 | 75 | 45 | 1 | 2 |

As shown in Table 1, the incentive DR profit optimization algorithm engine collects data about the number of customer objects participating in demand response resources, an increase/decrease rate of power used by customer object loads, a power generation reduction rate, a load reduction quantity, and a stop time.

Subsequently, a power reduction quantity target value of a load is set, as shown in Table 2.

TABLE 2

| | DR event period | | | | | | | |
|---|---|---|---|---|---|---|---|---|
| | 1 | 2 | 3 | 4 | 5 | 6 | 7 | 8 |
| Load power | 145 | 165 | 190 | 220 | 260 | 280 | 230 | 200 |
| reduction | | | | | | | | |
| target value | | | | | | | | |

Thereafter, a load reduction quantity and an estimated incentive are calculated for a customer object corresponding to the load power reduction quantity target value shown in Table 2.

The load reduction quantity and the estimated incentive are shown in Table 3.

TABLE 3

| | | | | | | | | | Load | |
|---|---|---|---|---|---|---|---|---|---|---|
| | | | | | | | | | reduction | Estimated |
| Customer | DR event period | | | | | | | | quantity | incentive |
| object | 1 | 2 | 3 | 4 | 5 | 6 | 7 | 8 | (kW) | (won) |
| 1 | 10 | 15 | 23 | 46 | 54 | 36 | 80 | 5 | 180 | 1100 |
| 2 | 20 | 0 | 50 | 45 | 80 | 40 | 30 | 15 | 210 | 1450 |
| 3 | 45 | 20 | 60 | 80 | 150 | 110 | 60 | 70 | 240 | 2300 |
| 4 | 85 | 160 | 120 | 130 | 80 | 90 | 110 | 180 | 270 | 2456 |
| 5 | 60 | 80 | 110 | 60 | 210 | 235 | 189 | 230 | 300 | 3210 |

Since the load reduction quantity increases as the incentive increases, customer objects 4 and 5 having high incentives and load reduction quantities are set to an optimization model of customer objects participating in demand response resources.

A description will be given of a method for optimization modeling for forming a smart portfolio for optimum demand response resource configuration according to the present invention.

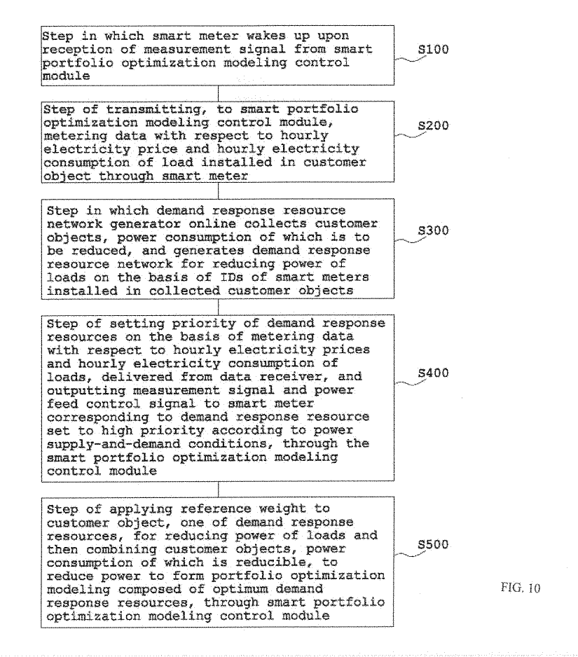

Referring to FIG. 10, a smart meter wakes up upon reception of a measurement signal from the smart portfolio optimization modeling control module (S100).

Thereafter, metering data with respect to an hourly electricity price and hourly electricity consumption of a load installed in a customer object is transmitted to the smart portfolio optimization modeling control module through the smart meter (S200).

Subsequently, the demand response resource network generator online collects customer objects that want to reduce power, and then generates a demand response resource network for reducing power of loads on the basis of IDs of smart meters installed in the collected customer objects (S300).

Thereafter, the smart portfolio optimization modeling control module sets priority of demand response resources on the basis of metering data corresponding to hourly electricity prices and hourly electricity consumption of loads, delivered from the data receiver, and outputs a measurement signal and a power feed control signal to a smart meter of a demand response resource set to high priority according to power demand-and-supply conditions (S400).

Finally, the smart portfolio optimization modeling control module adds a reference weight to a customer object, one of demand response resources, which can reduce power of loads, and then combines customer objects, power consumption of which can be reduced, to achieve optimization modeling for a portfolio composed of optimum demand response resources (S500), as shown in FIG. 8.

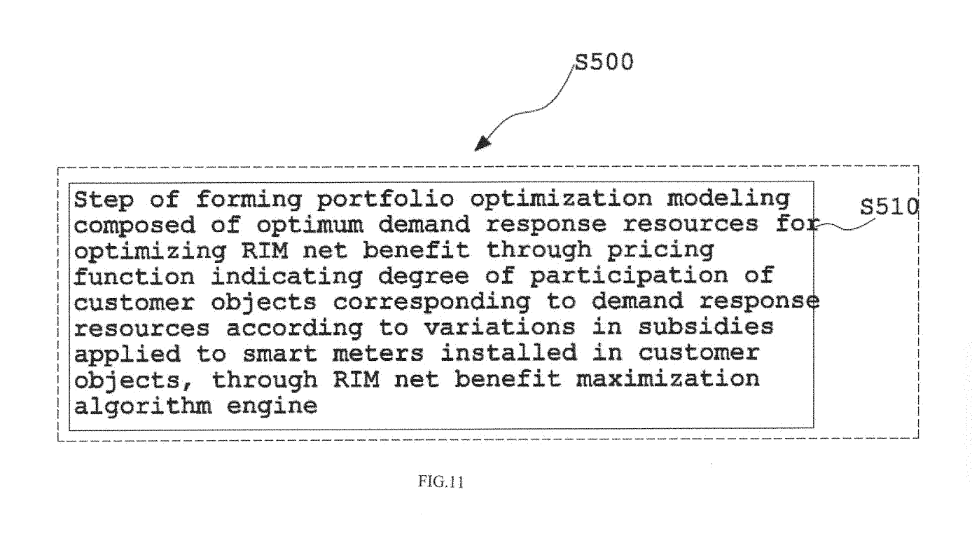

Specifically, the RIM net benefit maximization algorithm engine forms optimization modeling for a portfolio composed of optimum demand response resources for optimizing RIM net benefit through a pricing function indicating a degree of participation of customer objects corresponding to demand response resources according to variation in subsidies applied to smart meters installed in the customer objects (S510), as shown in FIG. 11.

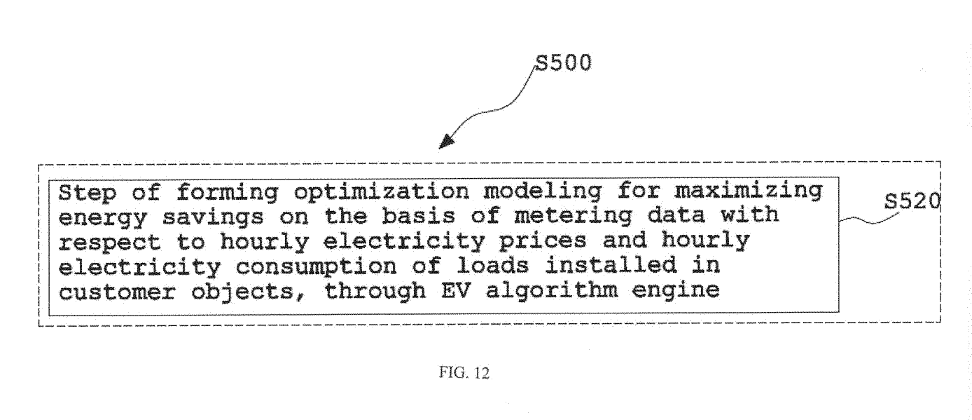

The EV algorithm engine forms optimization modeling for maximizing energy savings on the basis of metering data with respect to hourly electricity prices and hourly electricity consumption of loads installed in the customer objects (S520), as shown in FIG. 12.

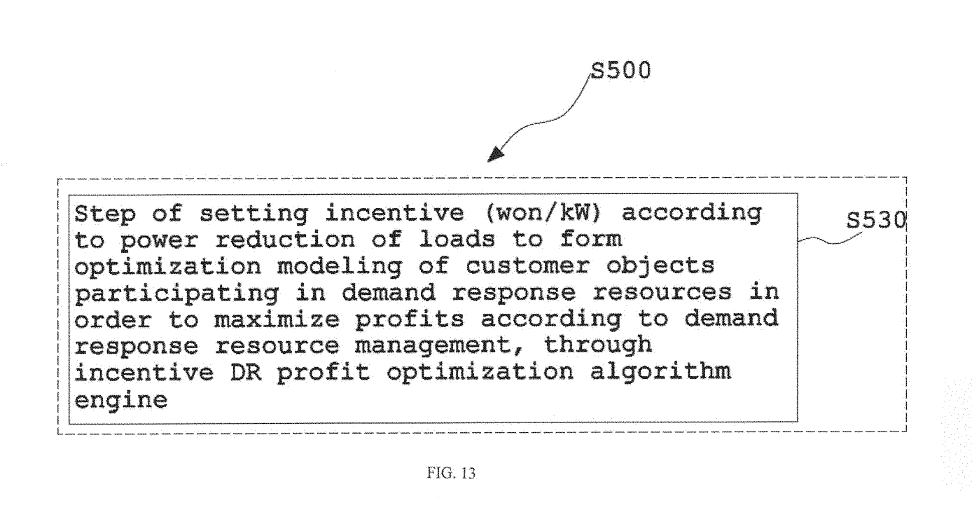

The incentive DR profit optimization algorithm engine sets an incentive (won/kW) according to power reduction quantity of a load and forms optimization modeling of customer objects participating in demand response resources in order to maximize profits according to demand response resource management (S530), as shown in FIG. 13.

What is claimed is:

1. An apparatus for smart portfolio optimization modeling for optimum demand response resource configuration, the apparatus comprising:
a smart meter installed in a customer object, operating upon reception of a measurement signal from a smart portfolio optimization modeling control module and transmitting metering data with respect to an hourly electricity price and hourly electricity consumption of a load installed in the customer object to the smart portfolio optimization modeling control module;
a demand response resource network generator for online collecting customer objects, power consumption of which is to be reduced, and generating a demand response resource network for reducing power of loads on the basis of IDs of smart meters installed in the collected customer objects; and
the smart portfolio optimization modeling control module connected to smart meters, sending the measurement signal to the smart meters, receiving metering data in response to the measurement signal, setting priority of response resources in consideration of loads of the customer objects included in the demand response resource network, and applying a reference weight to demand response resources to optimize the portfolio.

2. The apparatus according to claim 1, wherein the smart meter comprises:
a main body having a box form and protecting and supporting each device included in the smart meter from external pressure;
an external connector provided to one side of the exterior of the main body and connecting the smart meter to an input/output terminal of a load installed in a customer object;
a battery provided to one side of the inside of the main body and supplying power to each device;
a memory provided to one side of the battery and storing metering data with respect to an hourly electric price and hourly electricity consumption of a load;
a display provided to the surface of the main body and displaying a current operating state and metering data of a load on a screen;
a Wi-Fi communication module for transmitting metering data with respect to an hourly electricity price and hourly electricity consumption of a load to the remotely located smart portfolio optimization modeling control module, receiving a control command signal in response to the metering data, and delivering the control command signal to a load meter controller; and
the load meter controller connected to the external connector, the battery, the memory, and the display to control operations thereof, sending a measurement signal to a load to be measured, generating metering data with respect to an hourly electricity price and hourly electricity consumption of the load, storing the generated metering data in the memory, transmitting the metering data to the smart portfolio optimization modeling control module through the communication module, and outputting a power feed control signal to the load according to a real-time power feed instruction signal of the smart portfolio optimization modeling control module.

3. The apparatus according to claim 2, wherein the load meter controller includes a smart load controller for controlling loads to correspond to a reference set value in response to a frequency of an electrical grid.

4. The apparatus according to claim 1, wherein the smart portfolio optimization modeling control module comprises:
a control command signal output unit connected to the smart meter through the demand response resource network and outputting a measurement signal and a control command signal with respect to a power feed control signal to the smart meter;
a data receiver for receiving metering data with respect to hourly electricity prices and hourly electricity consumption of loads from the demand response resource network and delivering the metering data to a smart portfolio optimization modeling controller; and
the smart portfolio optimization modeling controller setting priority of demand response resources on the basis of the metering data with respect to the hourly electricity prices and hourly electricity consumption of loads, delivered from the data receiver, outputting a measurement signal and a power feed control signal to a smart meter corresponding to a demand response resource set to high priority according to power supply-and-demand conditions, applying a reference weight to a customer object, one of demand response resources, for reducing power of loads, and then combining customer objects, power consumption of which is to be reduced, to form portfolio optimization modeling composed of optimum demand response resources.

5. The apparatus according to claim 4, wherein the smart portfolio optimization modeling controller comprises:
a reference weight setting unit for setting a reference weight corresponding to one of power reduction reliability, power reduction quantity, type and number of loads whose power is reducible, a regular electricity consumption pattern, and type and properties of a customer object;
a priority setting unit for setting whether a customer object of a demand response resource is located in a capital area (Seoul, Gyeonggi, and Incheon) or a noncapital area (Jeju) to first priority, grouping customer objects in consideration of power reduction quantity and hourly complementary relation thereof, setting a customer object corresponding to a demand response resource having obligatory power reduction quantity exceeding a minimum reference set value and less than a maximum reference set value to second priority, and setting a demand response resource, to which customer objects corresponding to a minimum reference participant number per demand response reference are set, to third priority; and
a portfolio optimization modeling unit for forming portfolio optimization modeling composed of optimum demand response resources by combining customer objects, power consumption of which is to be reduced, to reduce power to maximize power reduction, on the basis of RIM (Ratepayer Impact Measure) net benefit maximization and energy savings maximization.

6. The apparatus according to claim 5, wherein the portfolio optimization modeling unit includes a RIM net benefit maximization algorithm engine for forming portfolio optimization modeling composed of optimized demand response resources for optimizing RIM net benefit through a pricing function indicating a degree of participation of customer objects corresponding to demand response resources according to variation in subsidies applied to smart meters installed in customer objects.

7. The apparatus according to claim 5, wherein the portfolio optimization modeling unit includes an EV (Energy Savings) algorithm engine for forming optimization modeling for maximizing energy savings on the basis of metering data with respect to hourly electricity prices and hourly electricity consumption of loads installed in customer objects.

8. The apparatus according to claim 5, wherein the portfolio optimization modeling unit includes an incentive DR profit optimization algorithm engine for setting an incentive (won/kW) according to power reduction of a load to form optimization modeling of customer objects participating in demand response resources in order to maximize profits according to demand response resource management.

9. A method for smart portfolio optimization modeling for optimum demand response resource configuration, the method comprising:
a smart meter waking up upon reception of a measurement signal from a smart portfolio optimization modeling control module;
transmitting, to the smart portfolio optimization modeling control module, metering data with respect to an hourly electricity price and hourly electricity consumption of a load installed in a customer object through the smart meter;
a demand response resource network generator online collecting customer objects, power consumption of which is to be reduced, and generating a demand response resource network for reducing power of loads on the basis of IDs of smart meters installed in the collected customer objects;
setting priority of demand response resources on the basis of metering data with respect to hourly electricity prices and hourly electricity consumption of loads, delivered from a data receiver, and outputting a measurement signal and a power feed control signal to a smart meter corresponding to a demand response resource set to high priority according to power demand-and-supply conditions, through the smart portfolio optimization modeling control module; and
applying a reference weight to a customer object, one of demand response resources, for reducing power of loads and then combining customer objects, power consumption of which is reducible, to form portfolio optimization modeling composed of optimum demand response resources, through the smart portfolio optimization modeling control module.

10. The method according to claim 9, wherein the forming of the portfolio optimization modeling comprises forming portfolio optimization modeling composed of optimum demand response resources for optimizing RIM net benefit through a pricing function indicating a degree of participation of customer objects corresponding to demand response resources according to variations in subsidies applied to smart meters installed in customer objects, through a RIM net benefit maximization algorithm engine.

11. The method according to claim 9, wherein the forming of the portfolio optimization modeling comprises forming optimization modeling for maximizing energy savings on the basis of metering data with respect to hourly electricity prices and hourly electricity consumption of loads installed in customer objects, through an EV algorithm engine.

12. The method according to claim 9, wherein the forming of the portfolio optimization modeling comprises setting an incentive (won/kW) according to power reduction of loads to form optimization modeling of customer objects participating in demand response in order to maximize profits according to demand response resource management, through an incentive DR profit optimization algorithm engine.
